(19) United States
(12) Patent Application Publication
(10) Pub. No.: US 2008/0286431 A1
(43) Pub. Date: Nov. 20, 2008

(54) Taco shell support device

(76) Inventor: Lazell C. Brown, Omaha, NE (US)

Correspondence Address: Law Offices of Adam H. Jacobs, Suite 726, 1904 Farnam Street, Omaha, NE, 68102, US

(21) Appl. No.: 11/804,248

(22) Filed: May 17, 2007

(51) Int. Cl. A47J 43/00; A23L 1/00

(52) U.S. Cl. 426/560; 99/645

(57) ABSTRACT

An improved taco shell support device has a frame having a top wall and at least one taco shell support structure mounted on the frame. The at least one taco shell support structure includes a taco-receiving slot formed in the top wall and first and second taco shell support walls extending downwards from opposite sides of the taco-receiving slot, each of the first and second taco shell support walls including upper and lower edges, the upper edges of the first and second taco shell support walls being spaced apart a greater distance than the lower edges of the first and second taco shell support walls whereas the first and second taco shell support walls are generally upwardly divergent from one another.

### BACKGROUND OF THE INVENTION

1. Technical Field

The present invention relates to taco shell holders and, more particularly, to an improved taco shell support device including a generally rectangular frame having a top wall, at least one taco shell support structure having a slot formed in the top wall, the taco shell support structure further including first and second taco shell support walls extending downwards from opposite sides of the taco-receiving slot, each of the first and second taco shell support walls including upper and lower edges, the upper edges of the first and second taco shell support walls being spaced apart a greater distance than the lower edges of the first and second taco shell support walls whereby the first and second taco shell support walls are generally upwardly divergent from one another.

2. Description of the Prior Art

Mexican food, particularly tacos, has become one of the most popular types of food served in the United States. The Mexican foods market, including fast food branches such as Taco Bell and Taco John's and foods for home consumption manufactured by such companies as Old El Paso and Pace, constitute multi-billion dollar business. Of course, while many individuals enjoy the fast food type of Mexican food, many others prefer to construct their tacos at home using fresh ingredients to make their tacos. A problem encountered in the home manufacture of tacos, however, is that as taco shells have a rounded base, it requires some degree of manual dexterity to support the taco shell in an upright position while filling the taco shell with beef, bean, vegetables, and/or salsa, depending upon the individual tastes of the taco builder. The likely result of such endeavor is the making of a mess wherein many of the taco ingredients end up outside the taco shell during the construction process. There is therefore a need for a taco shell support device which will support the taco shell in an upright position to simplify the taco shell filling process.

It has also been found to be preferable to present prepared food in an aesthetically pleasing format. In Mexican restaurants, the tacos are often brought to the table on their side on a plate, which can lead to much of the taco filling falling out of the taco shell onto the plate, necessitating action by the food consumer to replace the taco fillings in the taco shell. It may be preferable to serve the tacos in an upright position to prevent the taco fillings from falling out of the taco shell and, therefore, there is a need for a device which will permit the serving of the tacos in an upright position, which will be aesthetically pleasing.

Also, the home consumer of tacos will want to enjoy the benefits of any such taco shell holding device, but any such device must be easy to use and relatively inexpensive, otherwise the consumer will not purchase the shells and device. There is therefore a need for a taco shell holder which is lightweight yet sturdy, which readily accepts and supports taco shells therein, which is stackable and which will not collapse during the taco shell filling process.

Finally, it is common for the taco shells to be prepared in an ordinary manner by heating the shells on their sides on a baking sheet. However, one major problem encountered in this type of preparation is that the taco shells often close during the cooking, thus rendering them unsuitable for use for tacos. If the taco shells were supported in an upright position during the baking process, the percentage of usable shells would be greatly increased. Furthermore, once the cooking process is completed, if the taco shells were supported on such an ovenable support device, the tacos could be filled and prepared on the device, substantially eliminating the dangers inherent in removing recently heated taco shells from a baking tray, such as burns and the like. There is therefore a need for a taco shell support device which is ovenable.

Therefore, an object of the present invention is to provide an improved taco shell support device.

Another object of the present invention is to provide a taco shell support device which includes a generally rectangular box frame having a top wall, the top wall of the frame including at least one taco shell support structure for receiving and supporting a taco shell in an upright position.

Another object of the present invention is to provide an improved taco shell support device in which the taco shell support structure includes first and second taco shell support walls which extend downwards from the top wall and are angled towards one another to taper as they extend downwards, thus allowing multiple taco shell support devices to be stacked atop one another.

Another object of the present invention is to provide an improved taco shell support device which includes an arcuate top wall and taco shell support structures of increased height to support soft shell tacos and the like for filling thereof.

Another object of the present invention is to provide a taco shell support device which is constructed of a molded thermoplastic material to enable use of the taco shell support device in many different situations and which can be washed and reused yet may be easily disposed of should the user choose not to reuse the device.

Another object of the present invention is to provide a taco shell support device which is capable of supporting shells in the oven or microwave oven during the cooking process and can then be used for support during the filling process.

Finally, an object of the present invention is to provide taco shell support device which is relatively simple to manufacture and is safe, efficient and effective in use.

### SUMMARY OF THE INVENTION

The present invention provides an improved taco shell support device having a frame having a top wall and at least one taco shell support structure mounted on the frame. The at least one taco shell support structure includes a taco-receiving slot formed in the top wall and first and second taco shell support walls extending downwards from opposite sides of the taco-receiving slot, each of the first and second taco shell support walls including upper and lower edges, the upper edges of the first and second taco shell support walls being spaced apart a greater distance than the lower edges of the first and second taco shell support walls whereas the first and second taco shell support walls are generally upwardly divergent from one another.

The taco shell support device of the present invention provides numerous advantages over those devices found in the prior art. First, because the device is sturdy yet light in weight, it may be added to packages of shells without substantially increasing the size or weight of the package. Second, the plurality of slots in the holder permit the making of multiple tacos simultaneously, a boon for persons such as mothers who are making tacos for an entire family. Finally, because the present invention may be stacked atop one another, storage of the units is facilitated, as opposed to those devices found in the prior art. It is thus believed that the present invention provides a substantial improvement over the prior art.

### BRIEF DESCRIPTION OF THE DRAWINGS

FIG. 1 is a perspective view of the taco shell support device of the present invention with tacos being made therein;

FIG. 2 is a detail end elevational view of the taco shell support device of the present invention;

FIG. 3 is a perspective view of the taco shell support device;

FIG. 4 is a detailed end elevational cutaway view of the present invention showing how separate units are stackable on one another;

FIG. 5 is a perspective view of an alternative embodiment of the taco shell support device of the present invention with tacos being made therein;

FIG. 6 is a detail end elevational view of the embodiment of FIG. 5 of the taco shell support device of the present invention;

FIG. 7 is a perspective view of the embodiment of FIG. 5 of the taco shell support device; and

FIG. 8 is a detailed end elevational cutaway view of the embodiment of FIG. 5 showing how separate units are stackable on one another.

### DESCRIPTION OF THE PREFERRED EMBODIMENT

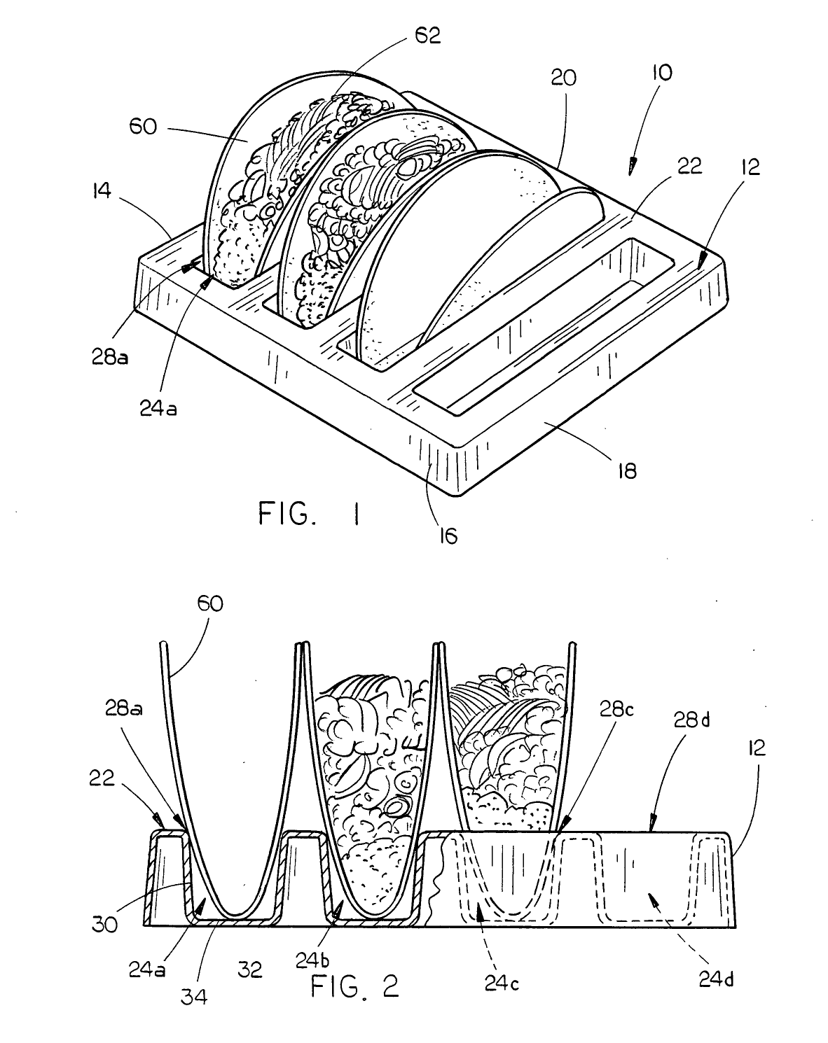

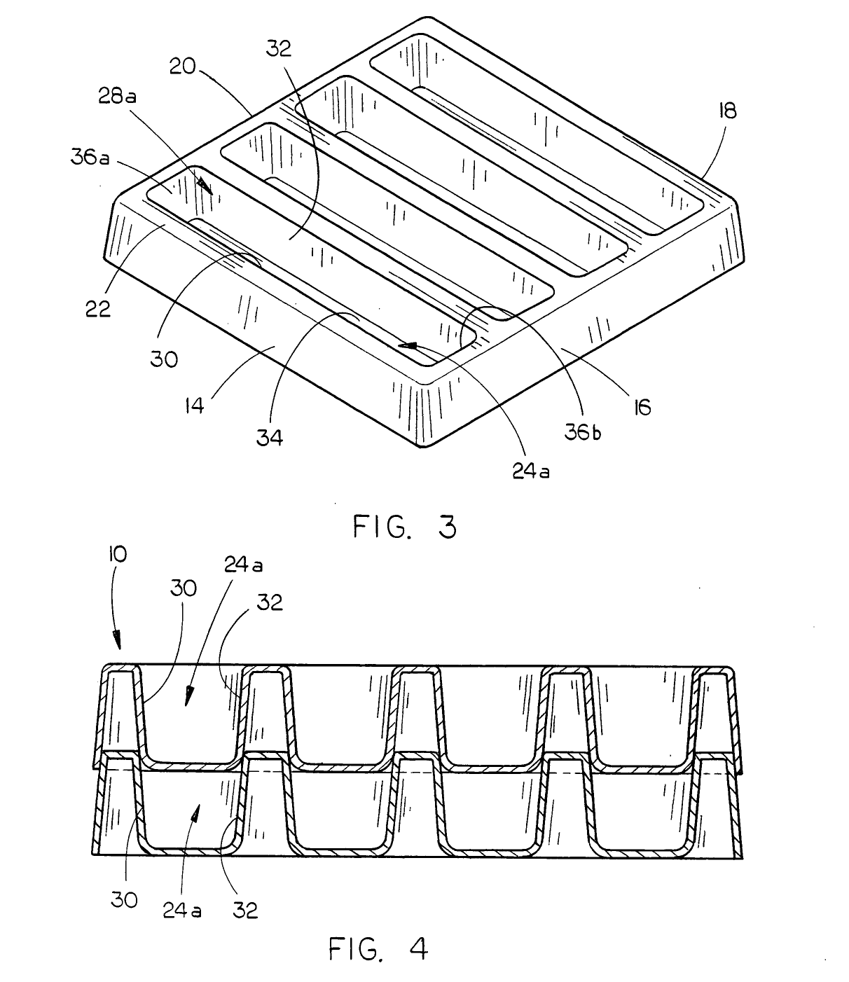

The taco shell support device 10 of the present invention is shown best in FIGS. 1-4 as including a base frame 12 which is generally rectangular in shape which includes four outer walls 14, 16, 18 and 20 and a top wall 22 which completes the generally rectangularly frame structure of the device 10 of the present invention with the device having approximate dimensions of eight inches by seven inches by one inch. Furthermore, it is preferred that the base frame 12 and other structural elements of the present invention be constructed of a molded plastic material which is heat and impact resistant, such as Polytetrafluoroethylene (PTFE) or other such thermoplastics having a wall thickness of approximately 30 to 70 mil, depending on the material used and the rigidity desired. Of course, the precise dimensions and construction materials used in connection with the present invention are not critical to the invention so long as the functionality of the invention is maintained.

Top wall 22 preferably includes a plurality taco shell support structures 24a, 24b, 24c, and 24d, each of which would include a taco shell receiving slot 28a, 28b, 28c, and 28d, each of which would have a length of approximately five to seven inches and a width of approximately one inch, although these dimensions may be modified as desired by the manufacturer of the present invention. The taco shell receiving slots 28a-d are designed to receive a taco shell 60 therein, as shown in FIG. 1, and the edges of the slot 28a may engage the external surface of the taco shell 60, as shown in FIGS. 1 and 4 such that the taco shell 60 is supported in a generally upright position by the taco shell receiving slot 28a.

Of course, the taco shell support device 10 of the present invention, specifically the taco shell support structures 24a, 24b, 24c, and 24d, require additional features in order to properly secure the taco shell support device 10 in its upright taco shell support position within a selected one of the taco shell support structures 24a-d, and in the preferred embodiment, this would consist of first and second taco shell support walls 30 and 32 which are connected to the side edges of the taco shell receiving slot 28a, 28b, 28c, and 28d, and extend downwards therefrom. In the preferred embodiment, the first and second taco shell support walls 30 and 32 are angled from vertical such that they are upwardly divergent, in other words, the first and second taco shell support walls 30 and 32 are farther apart at their upper edges as connected to the taco shell receiving slots 28a, 28b, 28c, and 28d than at their lower edges therebelow. The first and second taco shell support walls 30 and 32 preferably are angled approximately three degrees to ten degrees from vertical, with the preferred embodiment including angles of approximately four and one-half degrees. The upwardly divergent configuration of first and second taco shell support walls 30 and 32 has significant consequences, as will be discussed later in this disclosure.

Extending between and connecting the lower edges of the taco shell support walls 30 and 32 is a taco shell support base wall 34, and extending between and connecting the ends of the first and second taco shell support walls 30 and 32 to the taco shell support base wall 34 are taco shell support end walls 36a and 36b, whereby a taco-receiving channel is formed, which is referred to herein as one of the taco shell support structures 24a, 24b, 24c, and 24d. In the preferred embodiment, the taco shell support structure 24a would have a length of approximately three to six inches, a width of approximately one-half to one and one-half inches and a depth of approximately one-half to one and one-half inches, depending on the size and shape of the taco shell to be supported by the taco shell support structure 24a, and each of the remaining taco shell support structures 24b, 24c, and 24d would be of similar though not necessarily identical dimensions.

When the taco shell 60 sits within one of the taco shell support structures 24a, as shown in FIG. 1, the taco shell 60 would preferably be engaged by the side edges of the taco shell receiving slot 28a and would rest on taco shell support base wall 34. This combination provides an excellent degree of support for the taco shell 60 while simultaneously allowing easy access to the taco shell 60 for filling thereof.

Since the taco shell 60 is supported in the upright position by the slot 28a, both hands of the individual building the taco are available for adding the taco fillings 62, rendering it much less likely that spillage of the taco shell fillings will occur due to the availability of both hands. Once the taco shell 60 is filled, the taco may be quickly and easily removed from the slot 28a by simply lifting the taco shell 60 from the slot 28a. The plurality of slots 28a-d permit the simultaneous building of multiple tacos, which is a great convenience for the individual making the tacos. For example, if the individual building the tacos were a mother making tacos for her children, the simultaneous making of multiple tacos would allow each of the children to eat at the same time, rather than forcing the children to wait as a single taco is made at one time.

Once an individual purchased a box of taco shells, the individual would take the taco shells to his or her domicile, and begin to prepare the taco shells according to the instructions provided by the taco shell manufacturer while also preparing the taco filling ingredients, such as meat, refried beans, lettuce, onions, etc. The taco shells may be cooked in the ordinary manner, by being placed on a baking sheet or the like, or the taco shell support device 10 of the present invention may be used to support the taco shells 60 during the cooking process. In this case, the taco shells 60 would be inserted into the taco shell receiving slots 28a-d, each of which act to support the taco shells 60 in an upright position in combination with the first and second taco shell support walls 30 and 32 within each of the taco shell receiving slots 28a-d, and the preparer of the tacos would commence with the filling of the tacos. As each taco is prepared, it may be quickly and easily removed from the taco shell receiving slot 28a-d in which it is prepared and given to an individual for consumption. Once all of the taco shells have been consumed, the taco shell support device 10 of the present invention may be discarded or returned to its generally flat storage position for later use.

An important feature of the present invention deals with the preparation of the taco shells. As previously described, the taco shells could be prepared in the ordinary manner by heating the shells on their sides on a baking sheet. However, one major problem encountered in this type of preparation is that the taco shells often close during the cooking, thus rendering them unsuitable for use for tacos. The present invention provides a solution to this problem, as it is preferred that the taco shell support device 10 be constructed of a heat resistant molded plastic material that permits the taco shell support device 10 itself to be used in the cooking process. Generally, heat resistant plastics will not melt until reaching over 500° Fahrenheit, and some types of thermoplastics have even higher melting temperatures. Therefore, the present invention contemplates the insertion of the taco shells 60 into the taco shell receiving slots 28a-d and then the maker of the shells would place the entire taco shell support device 10 in the oven and cook the taco shells 60 in the upright position. This position will generally eliminate the collapsing of the shells which renders them useless for tacos, along with decreasing the cooking time as the shell is completely exposed to the heat of the oven. Upon completion of the heating process, the entire taco shell support device 10, including the taco shells 60 being supported thereon, can be removed from the oven and the shell filling process can be begun almost immediately. The tacos can thus be served quicker and with less mess than was previously possible without the present invention.

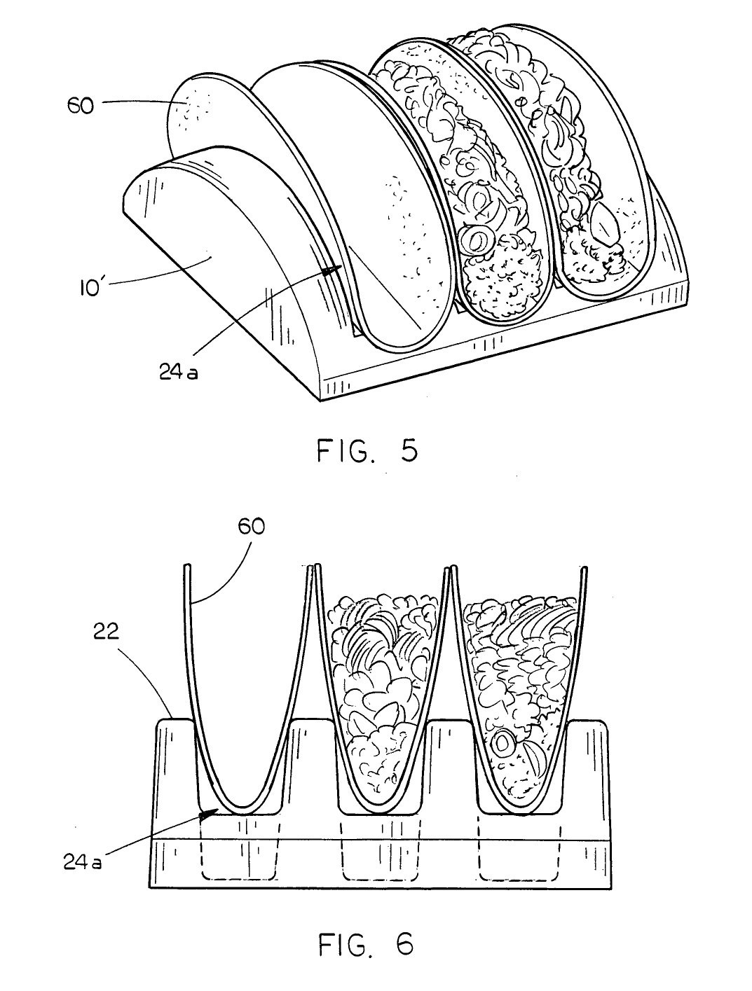

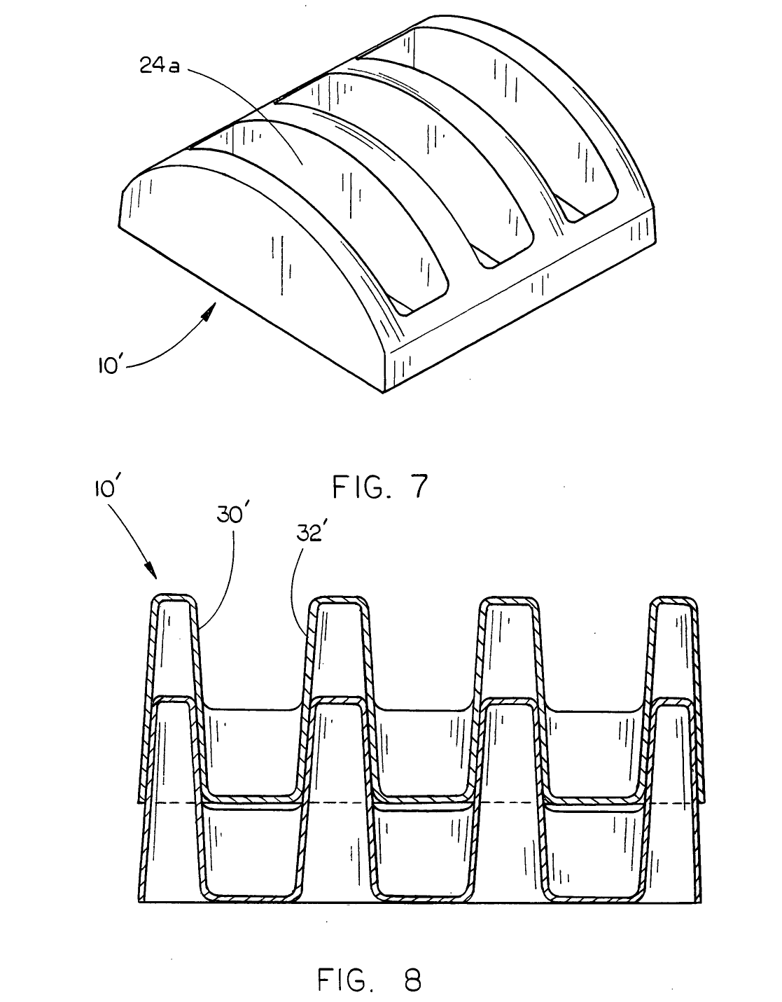

An alternative embodiment of the taco shell support device 10′ present invention is shown best in FIGS. 5-8 wherein top wall 22′ is curved to provide additional support for a soft shell taco shell supported therein. Each of the slots 28a-d will be formed in the top wall 22′ and would act to provide improved support for taco shell supported therein as the edges of each slot 28a-d would engage the taco shell at a point higher on the taco shell, thus increasing the stability of support for the taco shell. Of course, the first and second taco shell support walls 30 and 32 would extend upwards to the edges of each of the slots 28a-d and would function in the manner described previously.

An additional important feature of the present invention is that both the embodiment of FIGS. 1-4 and the embodiment of FIGS. 5-8 are stackable due to the upwardly divergent configuration of the first and second taco shell support walls 30 and 32 which permits multiple ones of the taco shell support device 10 and 10′ to be stacked atop one another for storage thereof, a feature not found in the prior art. In the preferred embodiment, the taco shell support device 10 and 10′ does not include a base wall for this very reason, and this is why each of the taco shell support structures 24a, 24b, 24c, and 24d include their own base walls 34. It has been found that the ability of the taco shell support devices 10 and 10′ to be stacked for storage contributes significantly to the reuse of the devices, and therefore encourages environmental preservation by reducing waste.

The taco shell receiving slots 28a-d are shown as being formed as generally rectangular in shape, but it may be preferable to form the slots in a generally elongated oval shape which has been found to accommodate and support certain types of taco shells better than the standard rectangular shaped slots shown in FIG. 1. However, it is to be understood that the precise size and shape of the slots 28a-d is not critical to the present invention so long as the functionality of the invention is not impaired.

It is to be understood that numerous modifications, substitutions and additions may be made to the taco shell support device 10 of the present invention which falls within the intended broad scope of the appended claims. For example the size, shape, dimensions and construction materials used in connection with the taco shell support device 10 of the present invention may be modified to accommodate various types of taco shells, so long as the intended functionality of the present invention is maintained. Furthermore, the number of slots formed in the top wall 22 of the present invention may be changed depending upon the number of taco shells which the device is intended to support. Finally, the convex curve used to construct the top wall 22′ of taco shell support device 10′ of the alternative embodiment of the present invention may be modified so long as the functionality of the invention is not significantly impaired.

There has thus been shown and described a taco shell support device 10 which accomplishes at least all of the stated objectives.

I claim:

1. A taco shell support device comprising:
a frame having a top wall;
at least one taco shell support structure mounted on said frame, said at least one taco shell support structure including;
a taco-receiving slot formed in said top wall; and
first and second taco shell support walls extending downwards from opposite sides of said taco-receiving slot, each of said first and second taco shell support walls including upper and lower edges, said upper edges of said first and second taco shell support walls being spaced apart a greater distance than said lower edges of said first and second taco shell support walls whereas said first and second taco shell support walls are generally upwardly divergent from one another.

2. The taco shell support device of claim 1 wherein said frame is a generally rectangular box further comprising four side walls connected to and extending downwards from said top wall.

3. The taco shell support device of claim 1 further comprising at least one taco shell support base wall, one of said at least one taco shell support base walls extending between and connecting said lower edges of each of said first and second taco shell support walls.

4. The taco shell support device of claim 3 further comprising a plurality of taco shell support end walls each extending between and connecting the ends of said first and second taco shell support walls and said at least one taco shell support base wall thereby forming a taco shell support structure.

5. The taco shell support device of claim 1 comprising a plurality of taco-receiving slots formed in said top wall extending generally longitudinally parallel with one another.

6. The taco shell support device of claim 5 wherein said taco-receiving slots are generally rectangular in shape each having a length at least three times greater than the width of said slots.

7. The taco shell support device of claim 5 wherein said taco-receiving slots are generally elongated oval in shape each having a length at least three times greater than the width of said slots.

8. The taco shell support device of claim 1 wherein said top wall is convexly curved such that the center of said top wall is higher than the ends of said top wall, said first and second taco shell support walls having center sections higher than the ends of said first and second taco shell support walls whereby said first and second taco shell support walls are operative to provide support for soft shell taco shells held within said at least one taco shell support structure.

9. The taco shell support device of claim 1 wherein said device is constructed of a thermoplastic material having a melting point greater than 450° Fahrenheit.

10. The taco shell support device of claim 1 wherein said device is constructed of a molded ovenable plastic material whereby said device is insertable into an oven for cooking of taco shells supported thereon.

11. In combination:
at least one taco shell; and
a taco shell support device including;
a frame having a top wall;
at least one taco shell support structure mounted on said frame, said at least one taco shell support structure including;
a taco-receiving slot formed in said top wall; and
first and second taco shell support walls extending downwards from opposite sides of said taco-receiving slot, each of said first and second taco shell support walls including upper and lower edges, said upper edges of said first and second taco shell support walls being spaced apart a greater distance than said lower edges of said first and second taco shell support walls whereas said first and second taco shell support walls are generally upwardly divergent from one another.

12. The combination of claim 11 wherein said frame is a generally rectangular box further comprising four side walls connected to and extending downwards from said top wall.

13. The combination of claim 11 wherein said at least one taco shell support structure further comprises at least one taco shell support base wall, one of said at least one taco shell support base walls extending between and connecting said lower edges of each of said first and second taco shell support walls.

14. The combination of claim 13 wherein said at least one taco shell support structure further comprises a plurality of taco shell support end walls each extending between and connecting the ends of said first and second taco shell support walls and said at least one taco shell support base wall thereby forming a taco shell support structure.

15. The combination of claim 11 comprising a plurality of taco-receiving slots formed in said top wall extending generally longitudinally parallel with one another.

16. The combination of claim 15 wherein said taco-receiving slots are generally rectangular in shape each having a length at least three times greater than the width of said slots.

17. The combination of claim 15 wherein said taco-receiving slots are generally elongated oval in shape each having a length at least three times greater than the width of said slots.

18. The combination of claim 11 wherein said top wall is convexly curved such that the center of said top wall is higher than the ends of said top wall, said first and second taco shell support walls having center sections higher than the ends of said first and second taco shell support walls whereby said first and second taco shell support walls are operative to provide support for soft shell taco shells held within said at least one taco shell support structure.

19. The taco shell support device of claim 1 wherein said device is constructed of a thermoplastic material having a melting point greater than 450° Fahrenheit.

20. The combination of claim 11 wherein said device is constructed of a molded ovenable plastic material whereby said device is insertable into an oven for cooking of taco shells supported thereon.
